(19) United States
(12) Patent Application Publication
(10) Pub. No.: US 2010/0052219 A1
(43) Pub. Date: Mar. 4, 2010

(54) MOLD FOR GOLF BALLS

(76) Inventor: Takahiro Sajima, Kobe-shi (JP)

Correspondence Address: BIRCH STEWART KOLASCH & BIRCH, PO BOX 747, FALLS CHURCH, VA, 22040-0747, US

(21) Appl. No.: 12/552,114

(22) Filed: Sep. 1, 2009

(30) Foreign Application Priority Data
Sep. 2, 2008 (JP) 2008-224827
Sep. 2, 2008 (JP) 2008-224991

(51) Int. Cl. B28B 1/00; B29C 43/02

(52) U.S. Cl. 264/299; 425/357

(57) ABSTRACT

A mold 2 includes a pair of mold halves (upper mold half 4 and lower mold half 6). A spherical cavity is formed by mating upper mold half 4 and lower mold half 6. A large number of pimples 10 are provided on the cavity face of the upper mold half 4 and lower mold half 6. The upper mold half 4 and the lower mold half 6 have flat plane 14, protrusions 16 and recesses 18, respectively. Each protrusion 16 projects from the equator Eq. Each recess 18 is depressed from the equator Eq. The protrusion 16 includes a part of the pimple 10. A central angle α between a protrusion (a) and a protrusion (b) adjacent to the protrusion (a) is different from the central angle β between the protrusion (a) and a protrusion (c) adjacent to the protrusion (a). The absolute value of a difference (α−β) is equal to or greater than 10°.

This application claims priority on Patent Application No. 2008-224827 and Patent Application No. 2008-224991 filed in JAPAN on Sep. 2, 2008. The entire contents of the Japanese Patent Applications are hereby incorporated by reference.

### BACKGROUND OF THE INVENTION

1. Field of the Invention

The present invention relates to molds of golf balls. More particularly, the present invention relates to a mold on the cavity face of which is provided with a large number of pimples for forming dimples.

2. Description of the Related Art

Golf balls have a large number of dimples on the surface thereof. The dimples disrupt the airflow around the golf ball during its flight to cause turbulent flow separation. By causing the turbulent flow separation, separating points of the air from the golf ball shift backwards leading to the reduction of drag. The turbulent flow separation prolongs the gap between the separating point on the upper side and the separating point on the lower side of the golf ball, which results from the backspin, thereby enhancing the lift force that acts upon the golf ball. Reduction in drag and elevation of lift force are referred to as “dimple effect”. Excellent dimples disrupt the air flow more efficiently.

In general, golf balls are formed using a mold having upper and lower mold halves each having a hemispherical cavity. Assuming that the upper mold half cavity is northern hemisphere of the globe and that the lower mold half cavity is southern hemisphere of the globe, the upper mold half and the lower mold half are mated on an equator face (plane including the equator). A large number of pimples are provided on the inner surface of the mold, and dimples are formed on the surface of the golf ball by means of the pimples. The dimple has a shape inverted from the shape of the pimple.

Since the molding material (for example, synthetic resin) leaks outside from a parting face of the upper mold half and the lower mold half, a flash is generated along the equator portion on the surface of the golf ball. The flash is generated along the parting line. This flash is ground and removed with a whetstone or the like. Removal of the flash generated inside the dimple is difficult. In order to facilitate the removal of the flash, any dimple is not formed on the equator. In other words, no pimple is provided on the parting face of the mold. A great circle path is formed on the seam of the golf ball obtained with this mold. The great circle path agrees with the equator. When this great circle path agrees with a part where the greatest circumferential speed of the backspin is attained (hereinafter, may be also referred to as “fastest part”), sufficient dimple effect can not be achieved. The dimple effect achieved when the great circle path agrees with the fastest part is inferior to the dimple effect achieved when the great circle path does not agree with the fastest part. The difference between these dimple effects may deteriorate aerodynamic symmetry of the golf ball. The great circle path further impairs the appearance of the golf ball.

US2002-94886 (JP2002-159598) discloses a mold provided with a parting face having a horizontal plane and an inclined plane. In this mold, pimples can be arranged on the equator except for the parting face. This mold provides a golf ball having a non-smooth seam. This golf ball does not have a great circle path. Similar mold is disclosed also in US2004/41297 (JP2004-89549).

U.S. Pat. No. 5,947,844 (JP10-99469) discloses a mold having pins placed on the parting face. The pin forms a dimple on the golf ball. By this mold, a golf ball not having a great circle path is obtained.

U.S. Pat. No. 6,123,534 (JP11-137727) discloses a mold provided with a parting face having bulges. The bulge forms a dimple on the golf ball. By this mold, a golf ball not having a great circle path is obtained.

According to the golf ball obtained with the mold provided with a parting face having a horizontal plane and an inclined plane, the dimples are sparsely provided in the vicinity of the seam. There remains room for improvement of the aerodynamic symmetry of this golf ball. Also in the case of the golf balls obtained with the mold having a pin or a bulge, their aerodynamic symmetry and appearance are still unsatisfactory.

An object of the present invention is to provide a golf ball that is excellent in aerodynamic symmetry and appearance.

### SUMMARY OF THE INVENTION

The mold for a golf ball according to the present invention includes a pair of mold halves. On the cavity face of this mold is provided with a large number of pimples for forming dimples. Each mold half is provided with multiple protrusions that project from the equator. Each protrusion includes a part of the pimple.

These multiple protrusions include

(a) one protrusion,

(b) other protrusion adjacent to the protrusion (a), and

(c) still other protrusion adjacent to the protrusion (a). The central angle a between the protrusion (a) and the protrusion (b) is different from the central angle β between the protrusion (a) and the protrusion (c). The absolute value of the difference (α−β) is equal to or greater than 10°.

In other aspect, there is provided a mold for a golf ball according to present invention which includes a pair of mold halves. On the cavity face of this mold is provided with a large number of pimples for forming dimples. Each mold half is provided with multiple protrusions that project from the equator. Each protrusion includes a part of the pimple. The proportion P1 of the number of the protrusion that is adjacent to other protrusion belonging to other mold half that is distinct from the mold half to which itself belongs to, to the total number of the protrusions is equal to or greater than 50%. The proportion P5 of the number of the pimple that is present in the region on a latitude of equal to or less than 20° and has a diameter of less than 4.0 mm, to the total number of the pimples that are present in the region on a latitude of equal to or less than 20° is equal to or greater than 20% and equal to or less than 90%. The standard deviation of the diameters of all the pimples that are present in the region on a latitude of equal to or less than 20° is equal to or less than 0.15.

The method for manufacturing a golf ball according to the present invention includes the steps of

(1) Placing a material into a mold that include

a pair of mold halves,

on the cavity face of the mold being provided with a large number of pimples for forming dimples, wherein:

each mold half is provided with multiple protrusions that project from the equator;

each protrusion includes a part of the pimple;

the multiple protrusions include

(a) one protrusion

(b) other protrusion adjacent to the protrusion (a), and

(c) still other protrusion adjacent to the protrusion (a);

the central angle α between the protrusion (a) and the protrusion (b) is different from the central angle β between the protrusion (a) and the protrusion (c); and

the absolute value of the difference (α−β) is equal to or greater than 10°, and

(2) forming the dimples having a shape inverted from the shape of the pimple by allowing the material to flow in the mold.

In other aspect, the method for manufacturing a golf ball according to the present invention includes the steps of

(1) Placing a material into a mold that include

a pair of mold halves,

on the cavity face of the mold being provided with a large number of pimples for forming dimples, wherein:

each mold half is provided with multiple protrusions that project from the equator;

each protrusion includes a part of the pimple;

the proportion P1 of the number of the protrusions that is adjacent to other protrusion belonging to other mold half that is distinct from the mold half to which itself belongs to, to the total number of the protrusions is equal to or greater than 50%;
the proportion P5 of the number of the pimple that is present in the region on a latitude of equal to or less than 20° and has a diameter of less than 4.0 mm, to the total number of the pimples that are present in the region on a latitude of equal to or less than 20° is equal to or greater than 20% and less than 90%; and

the standard deviation of the diameters of all the pimples that are present in the region on a latitude of equal to or less than 20° is equal to or less than 0.15, and

(2) forming the dimples having a shape inverted from the shape of the pimple by allowing the material to flow in the mold.

### BRIEF DESCRIPTION OF THE DRAWINGS

FIG. 1 shows a cross-sectional view illustrating a mold for a golf ball according to one embodiment of the present invention;

FIG. 2 shows an enlarged view illustrating a part of the mold shown in FIG. 1;

FIG. 3 shows a perspective view illustrating a lower mold half of the mold shown in FIG. 1;

FIG. 4 shows an enlarged cross-sectional view illustrating a part of the mold shown in FIG. 1;

FIG. 5 shows another enlarged cross-sectional view illustrating a part of the mold shown in FIG. 1;

FIG. 6 shows a plan view illustrating a golf ball obtained with the mold shown in FIG. 1;

FIG. 7 shows a front view illustrating the golf ball shown in FIG. 6;

FIG. 8 shows a plan view illustrating the golf ball obtained with the mold according to Example 2 of the present invention;

FIG. 9 shows a front view illustrating the golf ball shown in FIG. 8;

FIG. 10 shows a plan view illustrating a golf ball obtained with a mold according to Example 3 of the present invention;

FIG. 11 shows a front view illustrating the golf ball shown in FIG. 10;

FIG. 12 shows a plan view illustrating a golf ball obtained with a mold according to Comparative Example 1;

FIG. 13 shows a front view illustrating the golf ball shown in FIG. 12;

FIG. 14 shows a plan view illustrating a golf ball obtained with a mold according to Comparative Example 2;

FIG. 15 shows a front view illustrating the golf ball shown in FIG. 14;

FIG. 16 shows a plan view illustrating a golf ball obtained with a mold according to Comparative Example 3;

FIG. 17 shows a front view illustrating the golf ball shown in FIG. 16;

FIG. 18 shows a plan view illustrating a golf ball obtained with a mold according to Comparative Example 4;

FIG. 19 shows a front view illustrating the golf ball shown in FIG. 18;

FIG. 20 shows a plan view illustrating a golf ball obtained with a mold according to Comparative Example 5;

FIG. 21 shows a front view illustrating the golf ball shown in FIG. 20;

FIG. 22 shows a plan view illustrating a golf ball obtained with a mold according to Comparative Example 6; and

FIG. 23 shows a front view illustrating the golf ball shown in FIG. 20.

### DESCRIPTION OF THE PREFERRED EMBODIMENTS

Hereinafter, the present invention will be described in detail according to the preferred embodiments with appropriate references to the accompanying drawings.

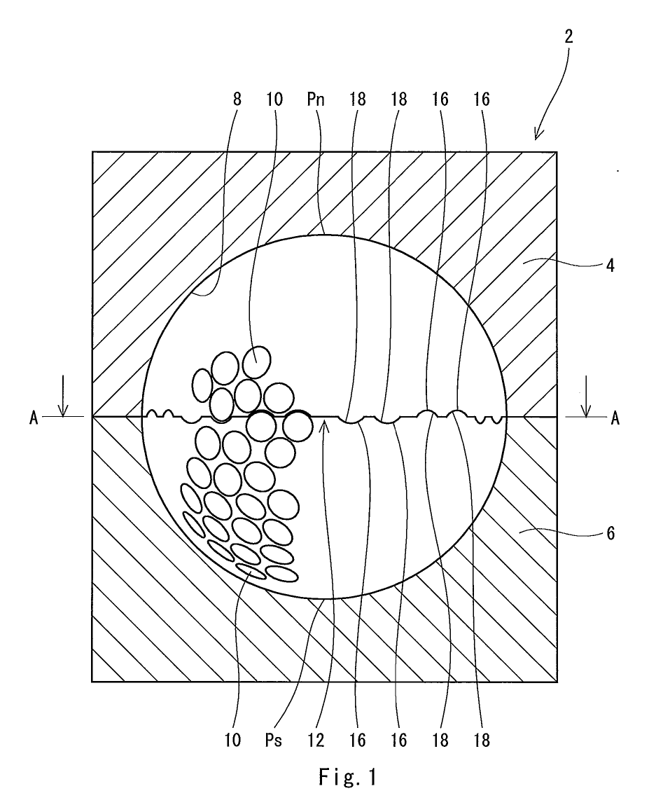

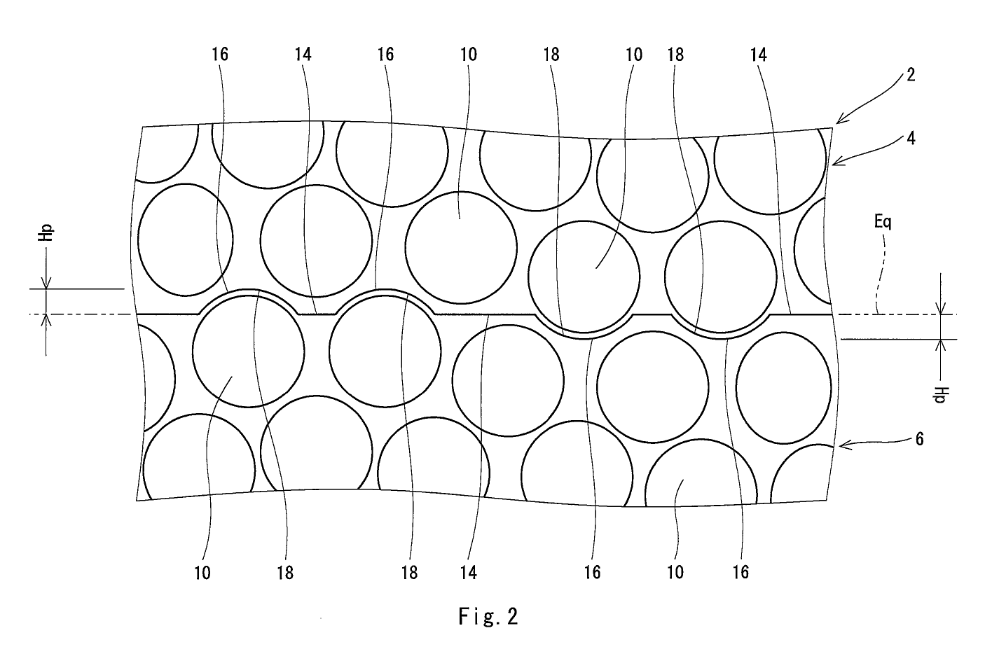

A mold 2 for a golf ball shown in FIGS. 1 and 2 includes a pair of mold halves 4 and 6. Specifically, the mold 2 includes upper mold half 4 and lower mold half 6. By mating the upper mold half 4 and the lower mold half 6, a spherical cavity is formed. A large number of pimples 10 are provided on cavity face 8 of the upper mold half 4 and the lower mold half 6. The contour of the pimple 10 has a circular shape. Although only a part of the pimples 10 are shown in FIG. 1, a large number of pimples 10 are arranged over the entire cavity face 8. As is clear from FIG. 1, parting face 12 between the upper mold half 4 and the lower mold half 6 has a non-planar shape. In FIG. 2, a chain double-dashed line indicated by reference sign Eq depicts an equator when the top of the cavity face 8 of the upper mold half 4 is assumed to be north pole Pn of a globe (see FIG. 1), while the bottom of the cavity face 8 of the lower mold half 6 is assumed to be southern pole Ps of the globe. Latitude of both north pole Pn and southern pole Ps is 90°. Latitude of the equator is 0°.

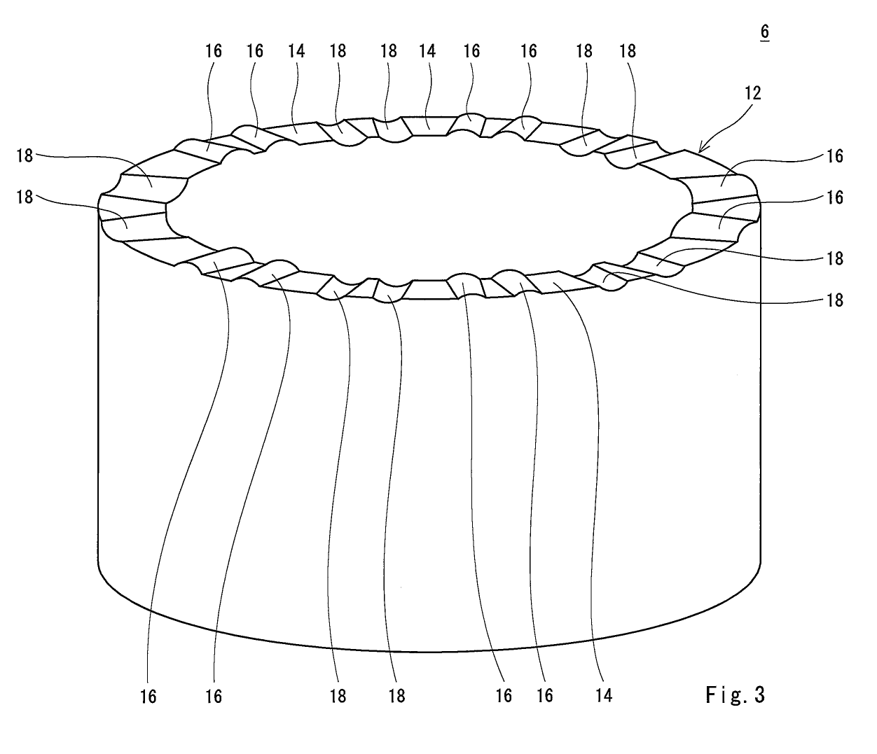

FIG. 3 shows a perspective view illustrating lower mold half 6 of the mold 2 shown in FIG. 1. Parting face 12 of this lower mold half 6 has flat plane 14, protrusions 16 and recesses 18. As is also shown in FIGS. 1 and 2, The flat plane 14 runs along the equator Eq. Each protrusion 16 projects from the equator Eq. Each recess 18 is depressed from the equator Eq. A group consisting of two protrusions 16, and a group consisting of two recesses 18 are alternately arranged along the circumferential direction. The number of the protrusions 16 is 10. The number of the recesses 18 is 10. The number of the protrusions 16 is the same as the number of the recesses 18. Although not shown in the figure, the upper mold half 4 also has a large number of protrusions 16 and a large number of recesses 18, similarly. When the upper mold half 4 is mated with the lower mold half 6, the protrusions 16 of the lower mold half 6 are fit in the recesses 18 of the upper mold half 4, while the recesses 18 of the lower mold half 6 are fit in the protrusions 16 of the upper mold half 4.

Since the protrusions 16 of the lower mold half 6 are fitted in the recesses 18 of the upper mold half 4, the number of the recesses 18 of the upper mold half 4 is the same as the number of the protrusions 16 of the lower mold half 6. Since the protrusions 16 of the upper mold half 4 are fitted in the recesses 18 of the lower mold half 6, the number of the protrusions 16 of the upper mold half 4 is the same as the number of the recesses 18 of the lower mold half 6. In this mold 2, each number of the protrusions 16 of the upper mold half 4, the recesses 18 of the upper mold half 4, the protrusions 16 of the lower mold half 6 and the recesses 18 of the lower mold half 6 is 10. This mold 2 has 20 protrusions 16 in total. This mold 2 has 20 recesses 18 in total.

As is seen from FIG. 2, the protrusion 16 includes a part of the pimple 10. The external margin of the protrusion 16 forms a circular arc. The external margin substantially agrees with the contour of the pimple 10. Since the protrusion 16 projects from the equator Eq, the pimple 10 included in the protrusion 16 intersects with the equator Eq. The center of the pimple 10 is not included in the protrusion 16.

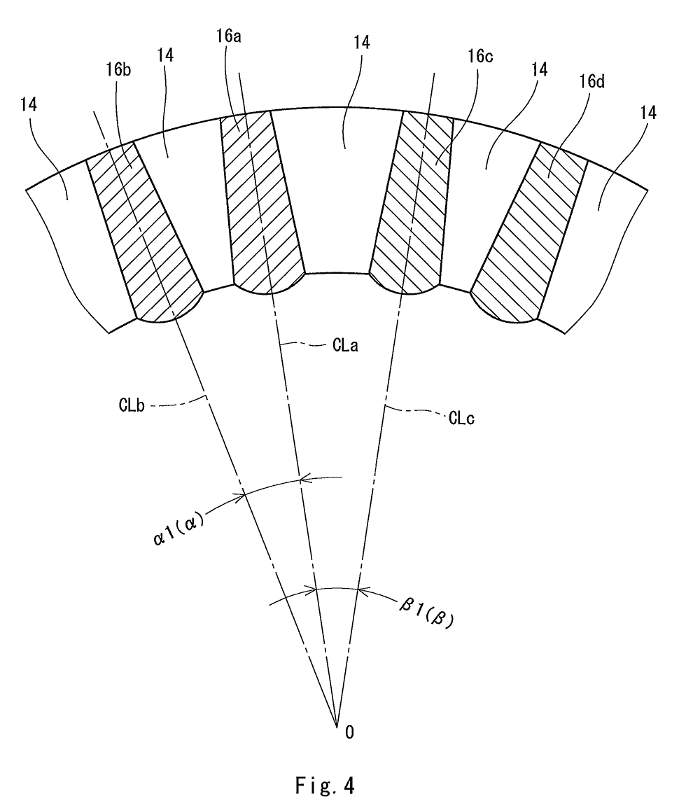

FIG. 4 shows an enlarged cross-sectional view illustrating a part of the mold shown in FIG. 1. FIG. 4 shows a cross-sectional view taken along a line A-A of FIG. 1. This cross section is taken along the equator Eq. In FIG. 4, the flat plane 14 of the lower mold half 6, two protrusions 16a and 16b of the lower mold half 6, and two protrusions 16c and 16d of the upper mold half 4 are depicted. The protrusion 16a is adjacent to the protrusion 16b. The protrusion 16a is also adjacent to the protrusion 16c. When any other protrusion is not present between two protrusions, these two protrusions are referred to be “adjacent”.

In FIG. 4, what is indicated by a reference sign O is a pivot of the cavity. The center lines CLa, CLb and CLc shown in FIG. 4 pass the point O. Center line CLa passes the center in meridional direction of protrusion 16a. Center line CLb passes the center in meridional direction of protrusion 16b. Center line CLc passes the center in meridional direction of protrusion 16c. In FIG. 4, what is indicated by reference sign α1 is the central angle between the protrusion 16a and the protrusion 16b. In FIG. 4, what is indicated by reference sign β1 is the central angle between the protrusion 16a and the protrusion 16c.

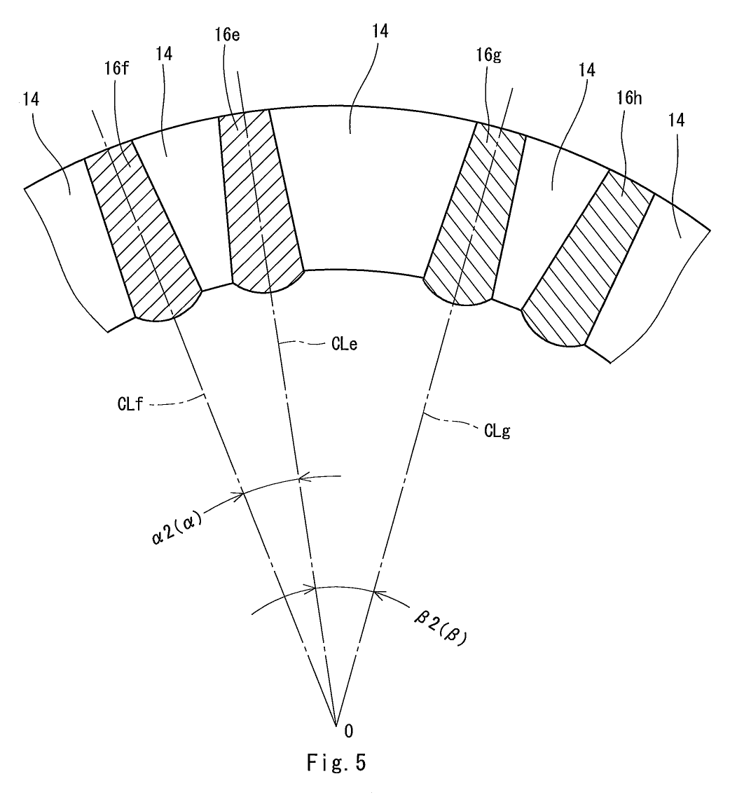

FIG. 5 shows another enlarged cross-sectional view illustrating a part of the mold shown in FIG. 1. FIG. 5 shows a cross-sectional view taken along a line A-A of FIG. 1. This cross section is taken along the equator Eq. FIG. 5 depicts a place that is different from the place depicted in FIG. 4. In FIG. 5, the flat plane 14 of the lower mold half 6, two protrusions 16e and 16f of the lower mold half 6, and two protrusions 16g and 16h of the upper mold half 4 are depicted. The protrusion 16e is adjacent to the protrusion 16f. The protrusion 16e is also adjacent to the protrusion 16h.

In FIG. 5, what is indicated by a reference sign O is a pivot of the cavity. The center lines CLe, CLf and CLg shown in FIG. 5 pass the point O. Center line CLe passes the center in meridional direction of protrusion 16e. Center line CLf passes the center in meridional direction of protrusion 16f. Center line CLg passes the center in meridional direction of protrusion 16g. In FIG. 5, what is indicated by reference sign α2 is the central angle between the protrusion 16e and the protrusion 16f. In FIG. 5, what is indicated by reference sign β2 is the central angle between the protrusion 16e and the protrusion 16g.

The angle α at the place shown in FIG. 5 (i.e., α2) is identical to the angle α at the place shown in FIG. 4 (i.e., α1). On the other hand, the angle β at the place shown in FIG. 5 (i.e., β2) is greater than the angle β of at the place shown in FIG. 4 (i.e., β1). In other words, a pair of angles (α,β) at the place shown in FIG. 5 is different from the pair of angles (α,β) at the place shown in FIG. 4. The angle α2 may be different form the angle α1.

This mold 2 can be used in molding of golf balls. This mold 2 can be used in compression molding, injection molding, cast molding and the like. In any of these methods, a material is placed in the mold 2. The material flows in the mold 2, whereby dimples having a shape inverted from the shape of the pimple 10 are formed.

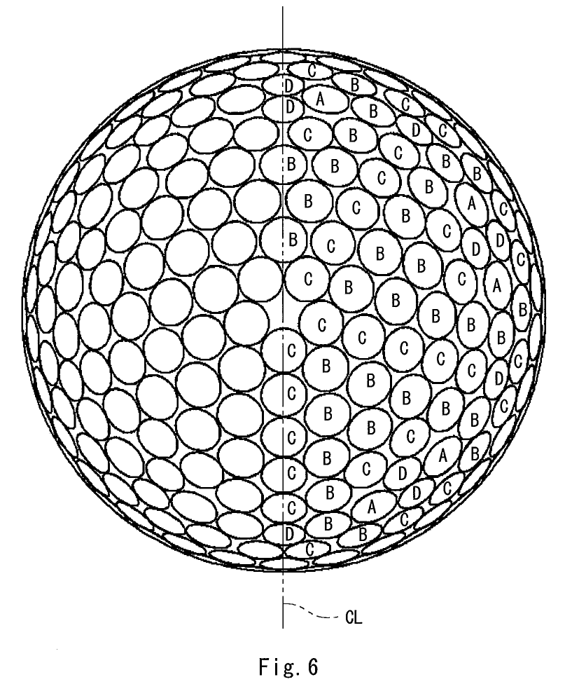

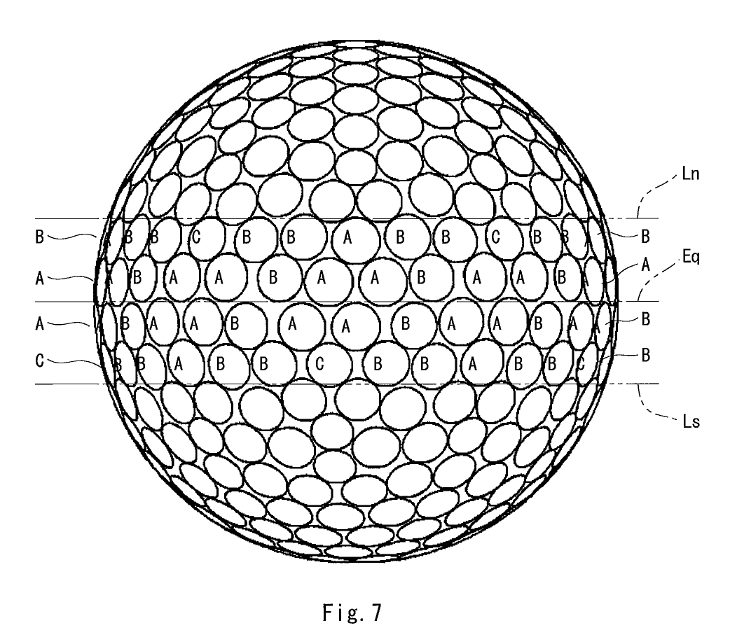

FIG. 6 shows a plan view illustrating golf ball 20 obtained with the mold 2 shown in FIG. 1, and FIG. 7 shows a front view of the same. This golf ball 20 has a large number of dimples 22 on the surface thereof. All dimples 22 are circular. In FIG. 6 and FIG. 7, types of the dimples 22 are indicated by reference signs A to D. This golf ball 20 has dimple A, dimple B, dimple C and dimple D. The number of the dimple A is 70; the number of the dimple B is 180; the number of the dimple C is 120; and the number of the dimple D is 30. Total number of the dimples 22 on this golf ball 20 is 400.

In FIG. 7, what is indicated by reference sign Ln is a latitude line on a north latitude of 20°, and what is indicated by reference sign Ls is a latitude line on a south latitude of 20°. On the surface of the golf ball 20 or on the cavity face 8, the region enclosed by latitude line Ln and latitude line Ls is a low-latitude region. On the surface of the golf ball 20 or on the cavity face 8, the region other than the low-latitude region is a high-latitude region. In FIG. 6, types of the dimples 22 being present in the high-latitude region are shown. When its center is positioned on a latitude beyond 20°, the dimple 22 corresponds to “dimple being present in the high-latitude region”. In FIG. 7, types of the dimples 22 being present in the low-latitude region are shown. When its center is positioned on a latitude 20° or below 20°, the dimple 22 corresponds to “dimple being present in the low-latitude region”.

The dimple 22 has a shape inverted from the shape of the pimple 10. The dimple A is formed by means of the pimple A. The dimple B is formed by means of the pimple B. The dimple C is formed by means of the pimple C. The dimple D is formed by means of the pimple D. The mold 2 shown in FIGS. 1 to 4 have 70 pimples A, 180 pimples B, 120 pimples C and 30 pimples D. The pimple A has a diameter of 4.00 mm. The pimple B has a diameter of 3.90 mm. The pimple C has a diameter of 3.75 mm. The pimple D has a diameter of 3.50 mm.

As described above, the mold 2 is provided with pimples 10 that intersect with the equator Eq. Therefore, the golf ball 20 obtained with this mold 2 has dimples 22 that intersect with the equator Eq. Any great circle path is not formed on the equator Eq of the golf ball 20. The dimple 22 that intersects with the equator Eq enhances the dimple effect when the equator Eq agrees with the fastest part of the backspin. This golf ball 20 is excellent in the aerodynamic symmetry. This golf ball 20 does not also have a great circle path that does not agree with the equator. This golf ball 20 is excellent in the appearance.

The protrusion 16a shown in FIG. 4 is adjacent to the protrusion 16c as described above. The protrusion 16a belongs to the lower mold half 6, while the protrusion 16c belongs to the upper mold half. In other words, the protrusion 16a is adjacent to the protrusion 16c belonging to one mold half 4 that is distinct from the mold half 6 to which the protrusion 16a belongs. On the golf ball 20 formed with this mold 2, the dimple 22 formed with the protrusion 16a belongs to the southern hemisphere, while the dimple 22 formed with the protrusion 16c belongs to the northern hemisphere.

The protrusion 16e shown in FIG. 5 is adjacent to the protrusion 16g as described above. The protrusion 16e belongs to the lower mold half 6, while the protrusion 16g belongs to the upper mold half. In other words, the protrusion 16e is adjacent to the protrusion 16g belonging to one mold half 4 that is distinct from the mold half 6 to which the protrusion 16e belongs. On the golf ball 20 formed with this mold 2, the dimple 22 formed with the protrusion 16e belongs to the southern hemisphere, while the dimple 22 formed with the protrusion 16g belongs to the northern hemisphere.

The proportion P1 of the number of the protrusion 16 that meets the following requirement 1 to the total number of the protrusions 16 is equal to or greater than 50%.

Requirement 1: being adjacent to other protrusion 16 belonging to other mold half that is distinct from the mold half to which itself belongs.

According to the golf ball 20 formed with the mold 2 having the proportion P1 of equal to or greater than 50%, when the equator Eq agrees with the fastest part of the backspin, it is highly frequent to yield the sequence of the dimple 20 belonging to the southern hemisphere followed by the dimple 20 belonging to the northern hemisphere, while it is also highly frequent to yield the sequence of the dimple 20 belonging to the northern hemisphere followed by the dimple 20 belonging to the southern hemisphere. This golf ball 20 achieves a superior dimple effect when the equator Eq agrees with the fastest part of the backspin. This golf ball 20 is excellent in the aerodynamic symmetry. In light of the aerodynamic symmetry, the proportion P1 is more preferably equal to or greater than 60%, and particularly preferably 100%. In the mold 2 shown in FIG. 1, the proportion P1 is 100%.

As shown in FIG. 4, the protrusion 16a is adjacent to the protrusion 16b belonging to the mold half 6 to which the protrusion 16a belongs, and is also adjacent to the protrusion 16c belonging to the mold half 4 that is distinct from the mold half 6 to which the protrusion 16a belongs. As shown in FIG. 5, the protrusion 16e is adjacent to the protrusion 16f belonging to the mold half 6 to which the protrusion 16e belongs, and is also adjacent to the protrusion 16g belonging to the mold half 4 that is distinct from the mold half 6 to which the protrusion 16e belongs. According to the golf ball 20 obtained with this mold 2, when the fastest part is positioned to agree with the equator, the dimples 22 which emerge upon backspin sequentially belong to “southern hemisphere, southern hemisphere, northern hemisphere, northern hemisphere, southern hemisphere, southern hemisphere, northern hemisphere, northern hemisphere and so forth”. Such a sequence of the dimples 22 according to this pattern serves in achieving a superior dimple effect. This golf ball 20 is excellent in the aerodynamic symmetry.

The mold 2 may include a protrusion 16 which is adjacent to the two protrusions 16 belonging to the mold half to which itself belongs. The mold 2 may include a protrusion 16 which is adjacent to the two protrusions 16 belonging to the mold half that is distinct form the mold half to which itself belongs.

It is preferred that the proportion P2 of the number of the protrusion 16 that meets the following requirement 2 to the total number of the protrusions 16 be equal to or greater than 50%.

Requirement 2: being adjacent to other protrusion 16 belonging to one mold half to which itself belongs, and also being adjacent to still other protrusion 16 belonging to another mold half that is distinct from the mold half to which itself belongs.

The golf ball 20 obtained with the mold 2 having the proportion P2 of equal to or greater than 50% is excellent in the aerodynamic symmetry. In this respect, the proportion P2 is more preferably equal to or greater than 60%, and particularly preferably 100%. In the mold 2 shown in FIG. 1, the proportion P2 is 100%.

As shown in FIG. 4, the central angle α (α1) is different from the central angle β (β1). As shown in FIG. 5, the central angle α (α2) is different form the central angle β (β2). By the mold 2 in which the central angle α is different from the central angle β, golf ball 20 having the dimples 22 arranged on the equator Eq at irregular intervals is obtained. This golf ball 20 achieves a superior dimple effect when the equator Eq agrees with the fastest part of the backspin. This golf ball 20 is excellent in the aerodynamic symmetry. In light of the aerodynamic symmetry, the absolute value of the difference (α−β) is preferably equal to or greater than 10°, more preferably equal to or greater than 11°, and particularly preferably equal to or greater than 12°. The absolute value of the difference is preferably equal to or less than 30°, and particularly preferably equal to or less than 24°.

It is preferred that the proportion P3 of the number of the protrusion 16 that meets the following requirement 3 to the total number of the protrusions 16 be equal to or greater than 50%.

Requirement 3: the central angle a with respect to one adjacent protrusion 16 being different from the central angle β with respect to another adjacent protrusion 16.

The golf ball 20 obtained with the mold 2 having the proportion P3 of equal to or greater than 50% is excellent in the aerodynamic symmetry. In this respect, the proportion P3 is more preferably equal to or greater than 60%, and particularly preferably 100%. In the mold 2 shown in FIG. 1, the proportion P3 is 100%.

When either the angle α or the angle β is small, an arrangement of protrusion 16 having great absolute value of the difference (α−β) may be achieved. In this respect, the smaller angle between the angle α and the angle β has an angle of preferably less than 10°, more preferably equal to or less than 9°, much more preferably equal to or less than 8°, and particularly preferably equal to or less than 7°. The smaller angle between the angle α and the angle β has an angle of preferably equal to or greater than 5°, and particularly preferably equal to or greater than 6°. The greater angle between the angle α and the angle β has an angle of preferably equal to or greater than 12° and equal to or less than 34°.

The proportion P4 of the number of the protrusion 16 that meets both the aforementioned requirements 2 and 3 to the total number of the protrusions 16 is preferably equal to or greater than 50%. The golf ball 20 obtained with the mold 2 having the proportion P4 of equal to or greater than 50% is excellent in the aerodynamic symmetry. In this respect, the proportion P4 is more preferably equal to or greater than 60%, and particularly preferably 100%. In the mold 2 shown in FIG. 1, the proportion P4 is 100%.

The absolute value of the difference (α−β) for the protrusion 16a (see FIG. 4) is different from the absolute value of the difference (α−β) for the protrusion 16e (see FIG. 5). The golf ball obtained with a mold 2 in which multiple protrusions 16 having different absolute value of the difference (α−β) one another are present is excellent in the aerodynamic symmetry.

The proportion P5 of the number of the pimple 10 that is present in the low-latitude region and has the diameter of 4.0 mm or less, to the total number of the pimples that are present in the low-latitude region is preferably equal to or greater than 20% and equal to or less than 90%. The golf ball 20 obtained with a mold having the proportion P5 of 20% or greater and 90% or less is excellent in the aerodynamic symmetry. In this respect, the proportion P5 is more preferably equal to or greater than 25%. The proportion P5 is more preferably equal to or less than 85%. The low-latitude region of the mold 2 shown in FIG. 1 has 50 pimples A, 60 pimples B and 10 pimples C. The total number of the pimples in the low-latitude region is 120. Therefore, the proportion P5 is 58%. The golf ball 20 in which multiple dimples 22 intersect with the equator Eq is excellent in the aerodynamic symmetry. In this respect, the number of the pimples 10 intersecting the equator Eq is preferably equal to or greater than 18, more preferably equal to or greater than 20, and particularly preferably equal to or greater than 24. From the standpoint that large dimples 22 may be arranged on the equator Eq, the number of the pimples 10 that intersect with the equator Eq is preferably equal to or less than 33, and more preferably equal to or less than 30. In the mold 2 shown in FIG. 1, 20 pimples 10 intersect with the equator Eq. Therefore, in the golf ball shown in FIG. 7, 20 dimples 22 intersect with the equator Eq.

It is preferred that the dimples 22 be densely arranged in the low-latitude region on the golf ball 20. This golf ball 20 achieves a superior dimple effect when the equator Eq agrees with the fastest part of the backspin. This golf ball 20 is excellent in the aerodynamic symmetry. This golf ball 20 is also excellent in the appearance. Arrangement of multiple kinds of the pimples 10 having diameters different from one another in the low-latitude region of the mold 2 enables achievement of high density of the dimples 22 in the low-latitude region. In light of the aerodynamic symmetry and the appearance, the number of the kinds of the pimples 10 that are present in the low-latitude region is preferably equal to or greater than 2, and more preferably equal to or greater than 3. In light of ease in producing the mold 2, the number of the kinds is preferably equal to or less than 10. In the mold 2 shown in FIG. 1, pimple A, pimple B and pimple C are present in the low-latitude region. The number of the kinds of the pimples 10 is three in the low-latitude region of the mold 2.

When all the pimples 10 that are present in the low-latitude region are sorted in descending order of the diameter, the ratio (Dx1/Dn1) of the average diameter Dx1 of the pimples 10 in the top 10% and the average diameter Dn1 of the pimples 10 in the bottom 10% is preferably equal to or less than 1.15. The golf ball 20 obtained with this mold 2 achieves a superior dimple effect when the equator Eq agrees with the fastest part of the backspin. This golf ball 20 is excellent in the aerodynamic symmetry. In light of the aerodynamic symmetry, the ratio (Dx1/Dn1) is more preferably equal to or less than 1.10, and particularly preferably equal to or less than 1.07. The low-latitude region of the mold 2 shown in FIG. 1 has 50 pimples A, 60 pimples B and 10 pimples C. The number of the pimples 10 in the low-latitude region is 120. Therefore, 12 pimples A correspond to the pimples 10 in the top 10%, and 10 pimples C and 2 pimples D correspond to the pimples 10 in the bottom 10%. In this mold 2, Dx1 is 4.00 mm, while Dn1 is 3.78 mm. Accordingly, the ratio (Dx1/Dn1) is 1.06.

When all the pimples 10 are sorted in descending order of the diameter, the ratio (Dx2/Dn2) of the average diameter Dx2 of the pimples 10 in the top 10% and the average diameter Dn2 of the pimples 10 in the bottom 10% is preferably equal to or less than 1.30. The golf ball 20 obtained with the mold 2 having the ratio (Dx2/Dn2) of equal to or less than 1.30 is excellent in the flight performance. In light of the flight performance, the ratio (Dx2/Dn2) is preferably equal to or less than 1.20, and more preferably equal to or less than 1.16. The ratio (Dx2/Dn2) is preferably equal to or greater than 1.05. The ratio (Dx2/Dn2) of the mold 2 shown in FIG. 1 is 1.12.

The standard deviation Σ1 of the diameters of all the pimples 10 that are present in the low-latitude region is preferably equal to or less than 0.15. The golf ball 20 obtained with this mold 2 achieves a superior dimple effect when the equator Eq agrees with the fastest part of the backspin. This golf ball 20 is excellent in the aerodynamic symmetry. In light of the aerodynamic symmetry, the standard deviation Σ1 is more preferably equal to or less than 0.12. The standard deviation Σ1 is preferably equal to or greater than 0.05. In the low-latitude region of the mold 2 shown in FIG. 1, the average diameter of the pimples 10 is 3.93 mm. Therefore, the standard deviation Σ1 is calculated by the following formula:

Σ1=(((4.00−3.93)²×50+(3.90−3.93)²×60+(3.75−3.93)²×10)/120)^{1/2}

In this golf ball 20, the standard deviation Σ1 is 0.07.

The standard deviation Σ2 of the diameters of all the pimples 10 is preferably equal to or less than 0.30. The golf ball 20 obtained with the mold 2 in which the standard deviation Σ2 is equal to or less than 0.30 is excellent in the flight performance. In light of the flight performance, the standard deviation Σ2 is more preferably equal to or less than 0.25, and particularly preferably equal to or less than 0.20. The standard deviation Σ2 of the mold 2 shown in FIG. 1 is 0.13.

In FIG. 2, what is indicated by arrowhead Hp is the height of the protrusion 16 from the equator Eq. In light of superior dimple effect achieved when the equator Eq agrees with the fastest part of the backspin, the height Hp is preferably equal to or greater than 0.2 mm, more preferably equal to or greater than 0.3 mm, and particularly preferably equal to or greater than 0.4 mm. In light of the durability of the mold 2, the height Hp is preferably equal to or less than 1.5 mm, and more preferably equal to or less than 1.3 mm.

The width of the intersection of the dimple 22 with the equator Eq is nearly the same as the height of the Hp of the protrusion 16. In light of the dimple effect, the width of the intersection is preferably equal to or greater than 0.2 mm, more preferably equal to or greater than 0.3 mm, and particularly preferably equal to or greater than 0.4 mm. In light of ease in manufacturing the golf ball 20, the width of the intersection is preferably equal to or less than 1.5 mm, and more preferably equal to or less than 1.3 mm.

In light of the ease in manufacturing the golf ball 20 and the durability of the mold 2, the absolute value of the difference (Hp1−Hp2) between the height Hp1 of the highest protrusion 16 and the height Hp2 of the lowest protrusion 16 is preferably equal to or less than 0.5 mm. Ideally, the difference (Hp1−Hp2) is zero. In other words, it is preferred that the heights of all the protrusions 16 from the equator be the same.

According to the present invention, the rate of sum total of the area of all the dimples 22 to the surface area of the phantom sphere of the golf ball 20 is referred to as an occupation rate. From the standpoint that a sufficient dimple effect is achieved, the occupation rate is preferably equal to or greater than 75%, more preferably equal to or greater than 76%, and particularly preferably equal to or greater than 77%. The occupancy rate is preferably equal to or less than 86%, more preferably equal to or less than 85%, and particularly preferably equal to or less than 84%.

According to the present invention, the term “dimple volume” means a volume of a part surrounded by a plane that includes the contour of the dimple 22, and the surface of the dimple 22. In light of suppression of hopping of the golf ball 20, the total volume of the dimples 22 is preferably equal to or greater than 250 mm³, more preferably equal to or greater than 260 mm³, and particularly preferably equal to or greater than 270 mm³. In light of suppression of dropping of the golf ball 20, the total volume is preferably equal to or less than 400 mm³, more preferably equal to or less than 390 mm³, and particularly preferably equal to or less than 380 mm³.

In light of suppression of hopping of the golf ball 20, the depth of the dimple 22 is preferably equal to or greater than 0.05 mm, more preferably equal to or greater than 0.08 mm, and particularly preferably equal to or greater than 0.10 mm. In light of suppression of dropping of the golf ball 20, the depth is preferably equal to or less than 0.60 mm, more preferably equal to or less than 0.45 mm, and particularly preferably equal to or less than 0.40 mm.

The diameter of the dimple 22 is preferably 2.00 mm or greater and 6.00 mm or less. By setting the diameter to be equal to or greater than 2.00 mm, a superior dimple effect can be achieved. In this respect, the diameter is more preferably equal to or greater than 2.20 mm, and particularly preferably equal to or greater than 2.40 mm. By setting the diameter to be equal to or less than 6.00 mm, fundamental feature of the golf ball 20 which is substantially a sphere can be maintained. In this respect, the diameter is more preferably equal to or less than 5.80 mm, and particularly preferably equal to or less than 5.60 mm.

In light of achievement of sufficient dimple effect, total number of the dimples 22 is preferably equal to or greater than 250, and particularly preferably equal to or greater than 270. In light of the possibility that respective dimples 22 can have a sufficient diameter, the total number is preferably equal to or less than 400, and particularly preferably equal to or less than 370.

### Examples

### Example 1

A rubber composition was obtained by kneading 100 parts by weight of polybutadiene (trade name “BR-730”, available from JSR Corporation), 30 parts by weight of zinc diacrylate, 6 parts by weight of zinc oxide, 10 parts by weight of barium sulfate, 0.5 parts by weight of diphenyl disulfide and 0.5 parts by weight of dicumyl peroxide. This rubber composition was placed into a mold having upper and lower mold halves each having a hemispherical cavity, and heated at 170° C. for 18 minutes to obtain a core having a diameter of 39.7 mm. On the other hand, 50 parts by weight of an ionomer resin (available from Du Pont-MITSUI POLYCHEMICALS Co., Ltd.; trade name “Himilan® 1605”), 50 parts by weight of other ionomer resin (available from Du Pont-MITSUI POLYCHEMICALS Co., Ltd.; trade name “Himilan® 1706”) and 3 parts by weight of titanium dioxide were kneaded to obtain a resin composition. Half shells were formed with this resin composition. The aforementioned core was covered by two half shells, and the core with the half shells was placed in the mold shown in FIG. 1. Specifications of the pimples of the mold are presented in Table 1 below. The half shells were compressed and heated in this mold to form a cover having a thickness of 1.5 mm. A large number of dimples having a shape inverted from the shape of the pimple were formed on the cover. The flash generated along the seam was removed by grinding. A clear paint including a two-part liquid curable polyurethane as a base was applied on the cover to give a golf ball having a diameter of 42.7 mm and a weight of 45.4 g. This golf ball had a PGA compression of about 85. This golf ball has a dimple pattern shown in FIG. 6 and FIG. 7.

### Examples 2 to 3 and Comparative Example 1 to 6

Golf balls were obtained in a similar manner to Example 1 except that the mold with the specifications presented in the following Tables 1 and 2 was used.

[Travel Distance Test]

A driver with a titanium head (trade name “XXIO”, available from Sumitomo Rubber Industries, Ltd., shaft hardness: X, loft angle: 9°) was attached to a swing machine, available from Golf Lab Co., Ltd. Then the golf ball was hit under the condition to provide a head speed of 49 m/sec, a launch angle being about 11° and give the backspin rate of about 3000 rpm. Accordingly, the distance from the launching point to the point where the ball stopped was measured. Under the condition during the test, it was almost windless. Twenty times measurements were carried out with pole shot and seam shot, respectively. Mean values of the travel distance are presented in Tables 3 to 5 below. The rotation axis of the seam shot passes both pole points. The rotation axis of the pole shot is perpendicular to the rotation axis of the seam shot.

[Appearance]

The appearance of the golf ball was visually observed. The grading was made based on the following criteria:

A: appearance being favorable,

B: appearance being somewhat unfavorable, and

C: appearance being unfavorable.

The results are presented in Tables 3 to 5 below.

TABLE 1
Specification of pimples

| | | | | | | Number | Number |
|---|---|---|---|---|---|---|---|
| | | | Diameter | Height | Volume | Intersecting | Low-latitude |
| | Kind | Number | (mm) | (mm) | (mm³) | with equator | region |
| Example 1 | A | 70 | 4.00 | 0.140 | 0.881 | 20 | 50 |
| | B | 180 | 3.90 | 0.140 | 0.838 | 0 | 60 |
| | C | 120 | 3.75 | 0.140 | 0.775 | 0 | 10 |
| | D | 30 | 3.50 | 0.140 | 0.675 | 0 | 0 |
| Example 2 | A | 50 | 4.40 | 0.142 | 1.081 | 0 | 0 |
| | B | 100 | 4.30 | 0.142 | 1.033 | 0 | 0 |
| | C | 60 | 4.20 | 0.142 | 0.985 | 0 | 40 |
| | D | 60 | 4.00 | 0.142 | 0.894 | 0 | 50 |
| | H | 30 | 3.90 | 0.142 | 0.850 | 30 | 30 |
| | E | 40 | 3.60 | 0.142 | 0.724 | 0 | 0 |
| Example 3 | A | 50 | 4.40 | 0.143 | 1.089 | 0 | 0 |
| | B | 110 | 4.30 | 0.143 | 1.040 | 20 | 20 |
| | C | 40 | 4.20 | 0.143 | 0.992 | 0 | 10 |
| | D | 20 | 4.00 | 0.143 | 0.900 | 0 | 0 |
| | H | 90 | 3.90 | 0.143 | 0.856 | 0 | 90 |
| | E | 30 | 3.60 | 0.143 | 0.729 | 0 | 10 |
| Compa. | A | 150 | 3.90 | 0.140 | 0.838 | 30 | 30 |
| Example 1 | B | 220 | 3.75 | 0.140 | 0.775 | 0 | 90 |
| | C | 40 | 3.60 | 0.140 | 0.714 | 0 | 20 |
| Compa. | A | 140 | 3.90 | 0.141 | 0.844 | 20 | 20 |
| Example 2 | B | 220 | 3.75 | 0.141 | 0.780 | 0 | 90 |
| | C | 50 | 3.60 | 0.141 | 0.719 | 0 | 30 |

TABLE 2
Specification of pimples

| | | | | | | Number | Number |
|---|---|---|---|---|---|---|---|
| | | | Diameter | Height | Volume | Intersecting | Low-latitude |
| | Kind | Number | (mm) | (mm) | (mm³) | with equator | region |
| Compa. | A | 50 | 4.30 | 0.140 | 1.018 | 0 | 0 |
| Example 3 | B | 210 | 3.90 | 0.140 | 0.838 | 0 | 70 |
| | C | 110 | 3.50 | 0.140 | 0.675 | 0 | 50 |
| | D | 40 | 3.30 | 0.140 | 0.600 | 0 | 20 |
| Compa. | A | 26 | 4.50 | 0.142 | 1.131 | 0 | 0 |
| Example 4 | B | 76 | 4.40 | 0.142 | 1.081 | 12 | 24 |
| | C | 102 | 4.30 | 0.142 | 1.033 | 0 | 48 |
| | D | 94 | 4.10 | 0.142 | 0.939 | 0 | 36 |
| | F | 12 | 3.90 | 0.142 | 0.850 | 0 | 12 |
| | E | 14 | 3.60 | 0.142 | 0.724 | 0 | 0 |
| Compa. | A | 60 | 4.60 | 0.144 | 1.198 | 18 | 42 |
| Example 5 | B | 42 | 4.40 | 0.144 | 1.096 | 0 | 24 |
| | C | 12 | 4.30 | 0.144 | 1.047 | 0 | 12 |
| | D | 66 | 4.20 | 0.144 | 0.999 | 0 | 12 |
| | E | 126 | 4.00 | 0.144 | 0.906 | 0 | 12 |
| | F | 12 | 3.90 | 0.144 | 0.862 | 0 | 0 |
| | G | 12 | 2.60 | 0.144 | 0.384 | 0 | 0 |
| Compa. | A | 80 | 4.55 | 0.139 | 1.131 | 0 | 0 |
| Example 6 | B | 80 | 4.45 | 0.139 | 1.082 | 0 | 36 |
| | C | 60 | 4.25 | 0.139 | 0.987 | 0 | 60 |
| | D | 40 | 4.10 | 0.139 | 0.919 | 0 | 0 |
| | E | 56 | 3.85 | 0.139 | 0.810 | 0 | 24 |
| | F | 14 | 3.00 | 0.139 | 0.493 | 0 | 0 |

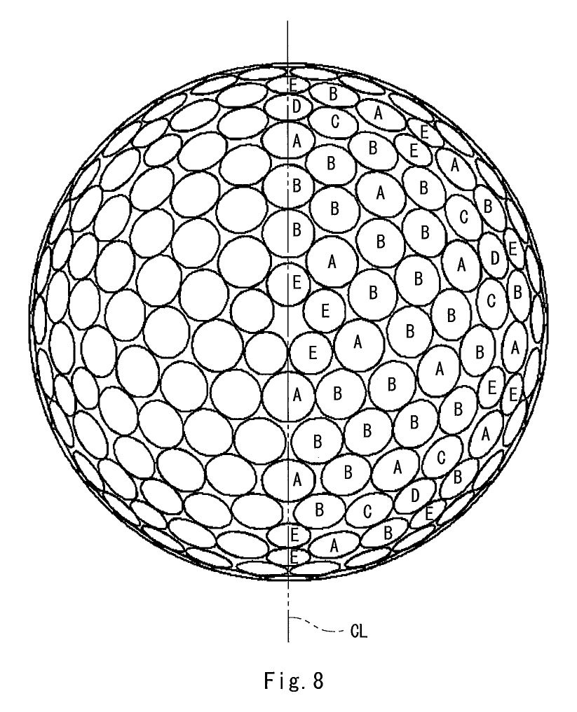

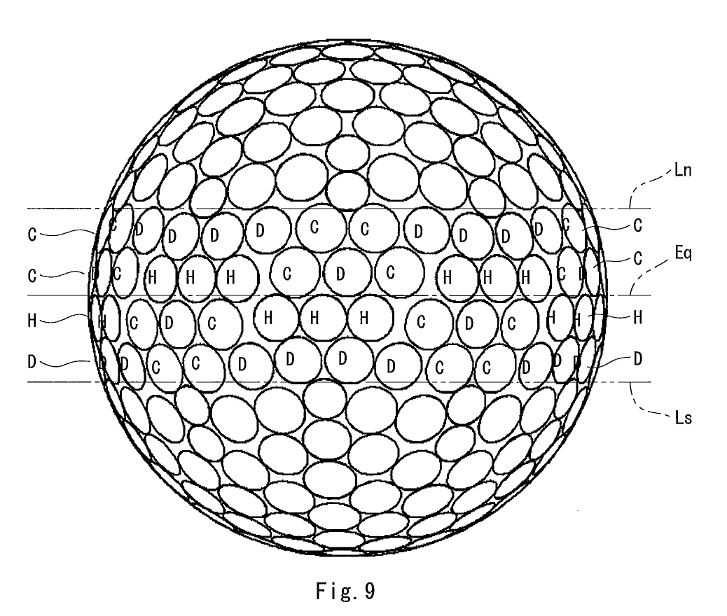

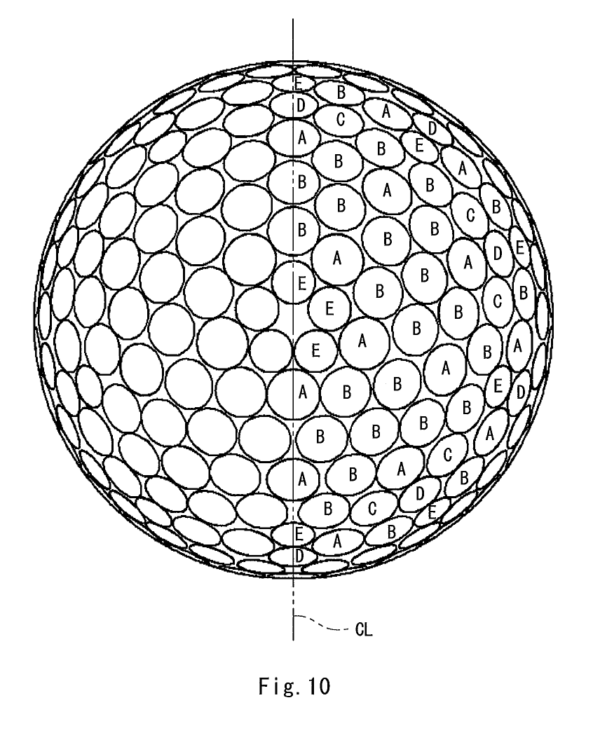

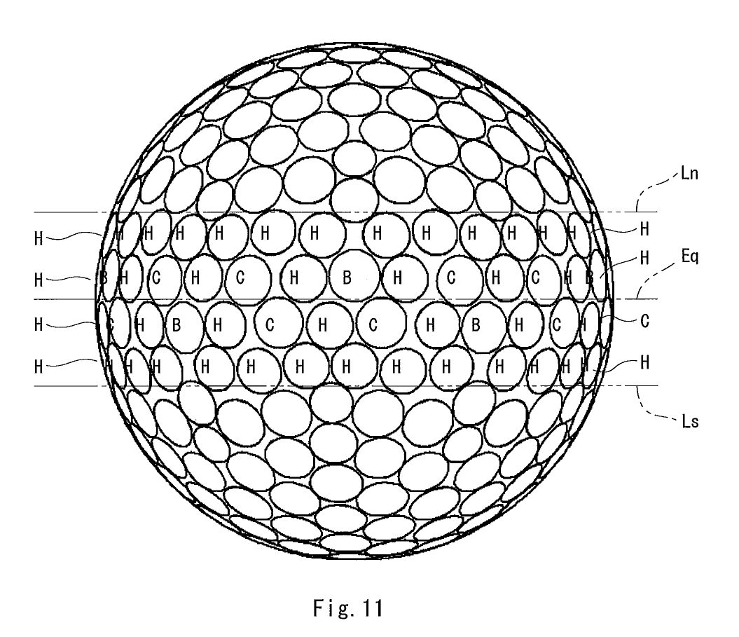

TABLE 3
Evaluation results

| | | | Example 1 | Example 2 | Example 3 |
|---|---|---|---|---|---|
| Specification | Number | | 400 | 340 | 340 |
| of pimples | Occupancy (%) | | 81.1 | 79.7 | 79.3 |
| (entire) | Σ2 | | 0.13 | 0.25 | 0.25 |
| | Dx2/Dn2 | | 1.12 | 1.22 | 1.21 |
| Specification | Number | | 120 | 120 | 120 |
| of pimples | Σ1 | | 0.07 | 0.12 | 0.15 |
| (low-latitude | Dx1/Dn1 | | 1.06 | 1.08 | 1.10 |
| region) | Diameter range | | 3.75-4.00 | 3.90-4.20 | 3.90-4.30 |
| | (mm) | | | | |
| | Kinds | | 3 | 3 | 3 |
| Number of protrusions | | | 20 | 30 | 20 |
| Adjacent of | *1 | α (deg.) | 6.0 | 10.6 | 23.2 |
| protrusions | | β (deg.) | 18.0 | 20.8 | 18.8 |
| | | Number | 10 | 10 | 10 |
| | | α (deg.) | 6.0 | 10.6 | 23.2 |
| | | β (deg.) | 30.0 | 8.8 | 6.8 |
| | | Number | 10 | 10 | 10 |
| | *2 | α (deg.) | — | 10.6 | — |
| | | β (deg.) | | 10.6 | |
| | | Number | | 10 | |
| | *3 | | — | — | — |

| Proporsion P1 (%) | | 100 | 67 | 100 |
|---|---|---|---|---|
| Proporsion P2 (%) | | 100 | 67 | 100 |
| Proporsion P3 (%) | | 100 | 67 | 100 |
| Proporsion P4 (%) | | 100 | 67 | 100 |
| Proporsion P5 (%) | | 58 | 25 | 75 |
| Plan view of golf ball | | FIG. 6 | FIG. 8 | FIG. 10 |
| Front view of golf ball | | FIG. 7 | FIG. 9 | FIG. 11 |
| Flight | Pole shot | 242.0 | 241.0 | 241.6 |
| distance (m) | Seat shot | 241.4 | 240.1 | 240.8 |

| | | | |
|---|---|---|---|
| Appearance | A | A | A |

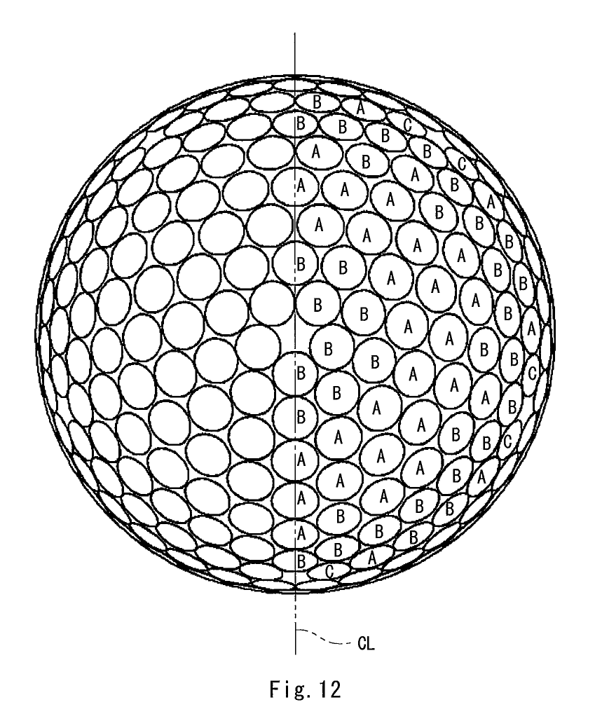

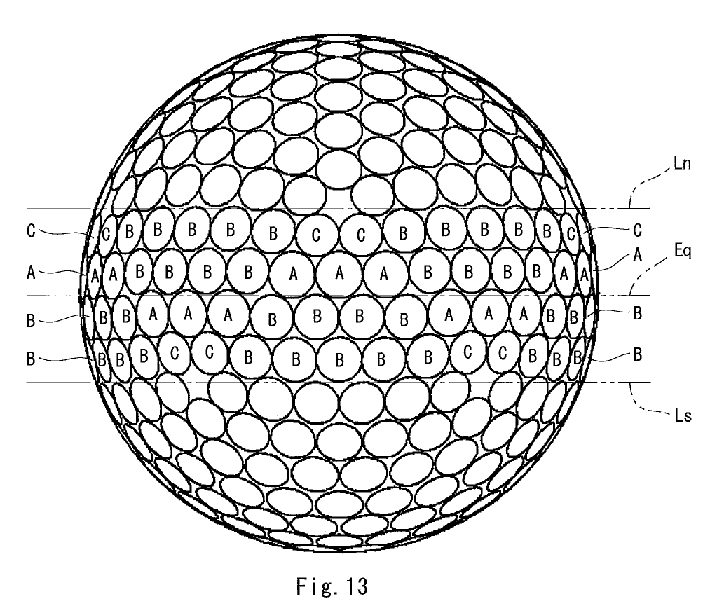

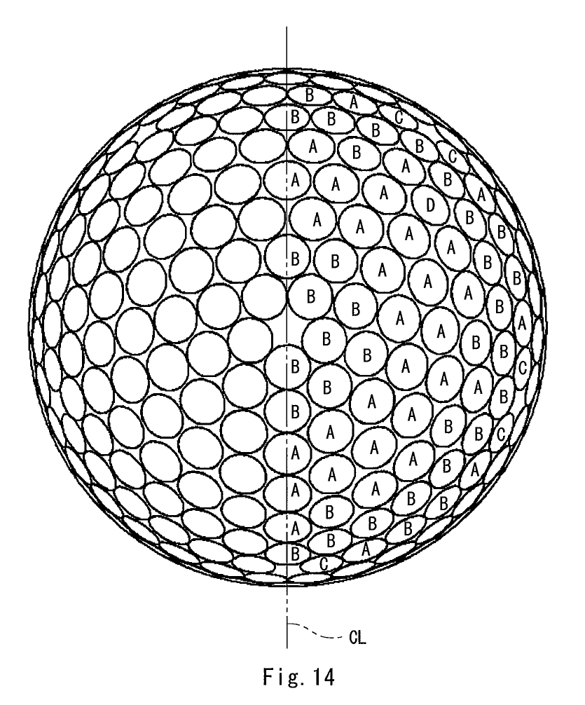

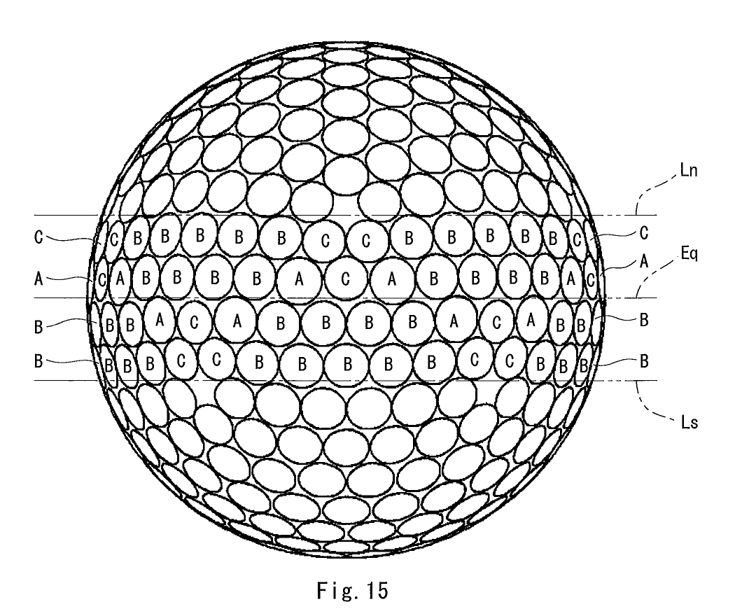

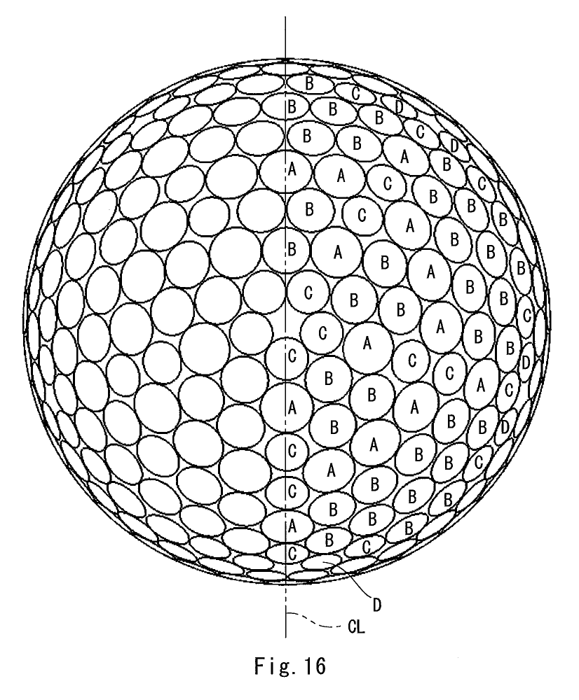

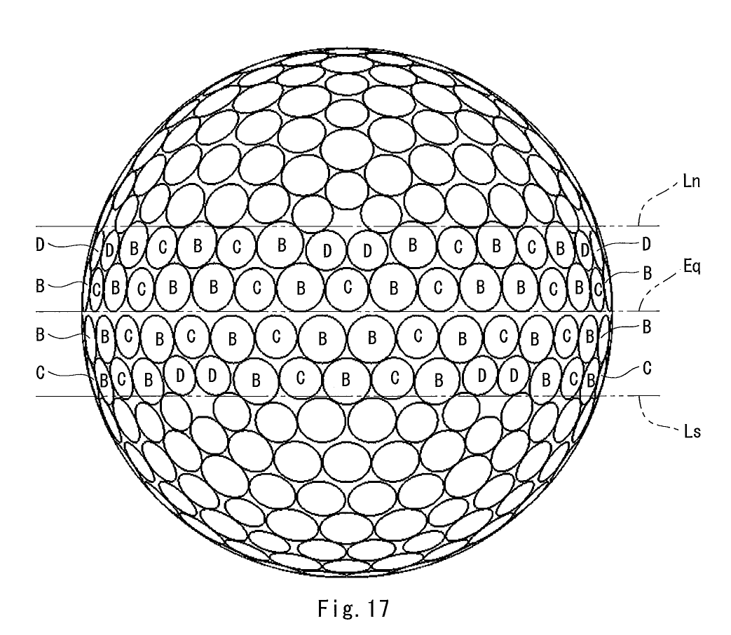

TABLE 4
Evaluation results

| | | | Compa. | Compa. | Compa. |
|---|---|---|---|---|---|
| | | | Example 1 | Example 2 | Example 3 |
| Specification | Number | | 410 | 410 | 410 |
| of pimples | Occupancy (%) | | 80.8 | 80.5 | 80.9 |
| (entire) | Σ2 | | 0.09 | 0.10 | 0.29 |
| | Dx2/Dn2 | | 1.08 | 1.08 | 1.30 |
| Specification | Number | | 140 | 140 | 140 |
| of pimples | Σ1 | | 0.09 | 0.09 | 0.24 |
| (low-latitude | Dx1/Dn1 | | 1.08 | 1.08 | 1.18 |
| region) | Diameter range | | 3.60-3.90 | 3.60-3.90 | 3.30-3.90 |
| | (mm) | | | | |
| | Kinds | | 3 | 3 | 3 |
| Number of protrusions | | | 30 | 20 | 0 |
| Adjacent of | *1 | α (deg.) | 20.5 | 21.1 | — |
| protrusions | | β (deg.) | 14.9 | 14.9 | |
| | | Number | 20 | 20 | |
| | *2 | α (deg.) | 10.5 | — | — |
| | | β (deg.) | 10.5 | | |
| | | Number | 10 | | |
| | *3 | | — | — | — |

| Proporsion P1 (%) | | 67 | 100 | — |
|---|---|---|---|---|
| Proporsion P2 (%) | | 67 | 100 | — |
| Proporsion P3 (%) | | 67 | 100 | — |
| Proporsion P4 (%) | | 67 | 100 | — |
| Proporsion P5 (%) | | 100 | 100 | 100 |
| Plan view of golf ball | | FIG. 12 | FIG. 14 | FIG. 16 |
| Front view of golf ball | | FIG. 13 | FIG. 15 | FIG. 17 |
| Flight | Pole shot | 240.1 | 240.4 | 237.6 |
| distance (m) | Seat shot | 238.9 | 239.3 | 235.3 |

| | | | |
|---|---|---|---|
| Appearance | B | B | C |

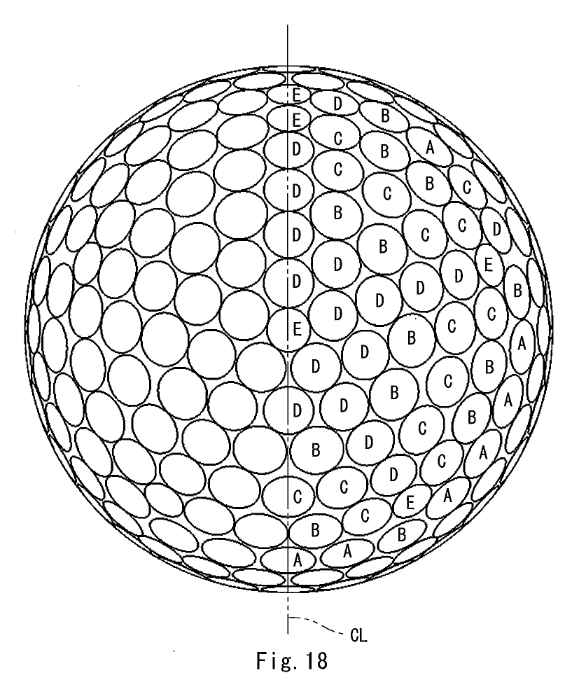

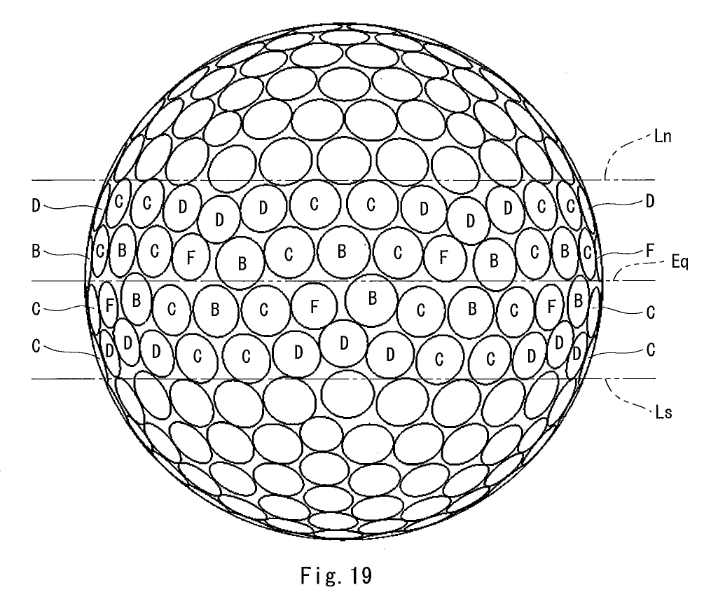

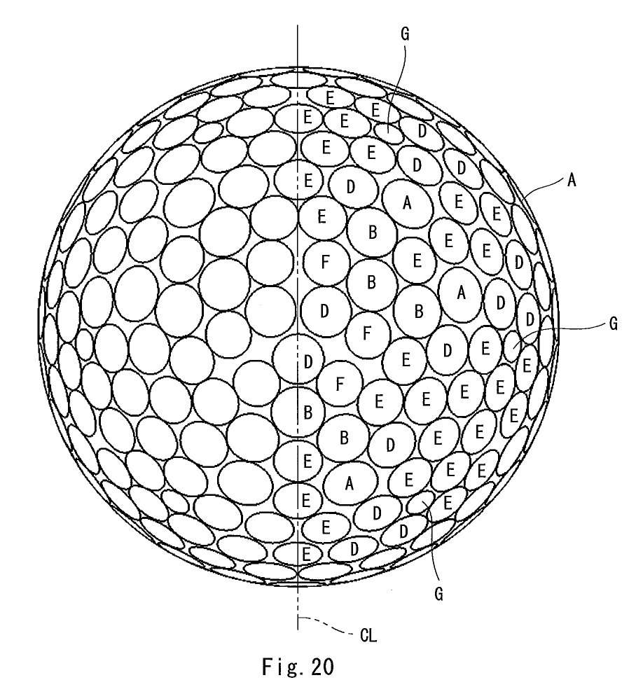

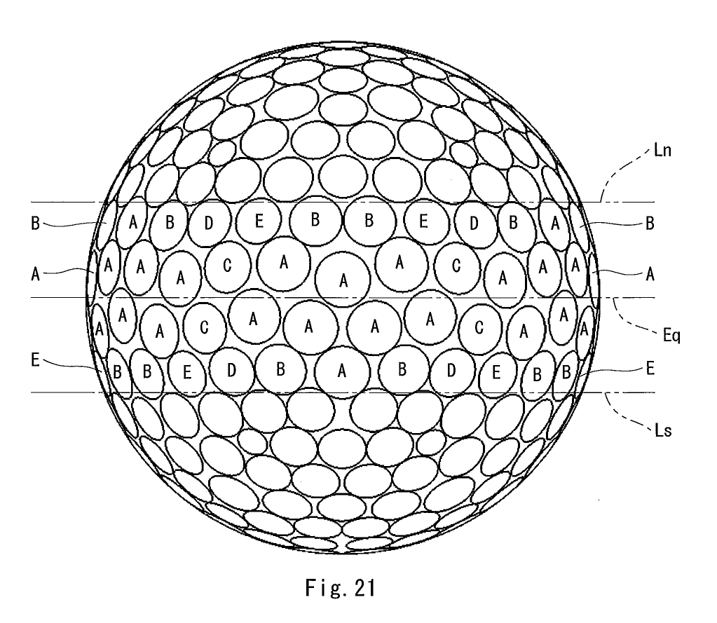

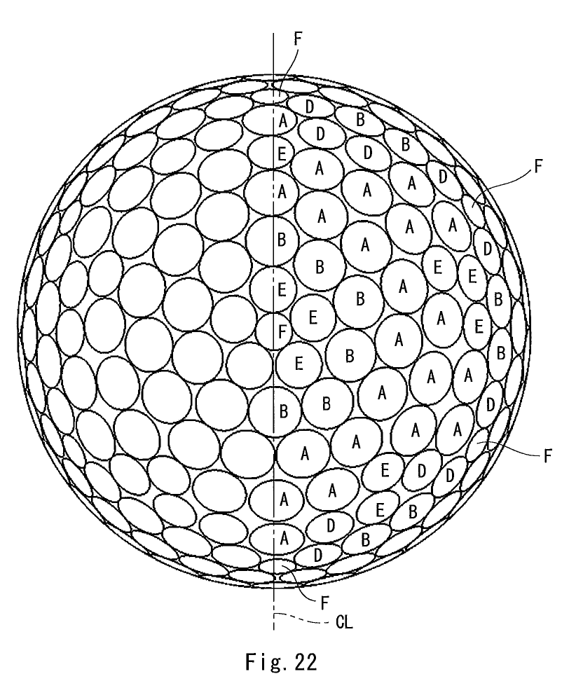

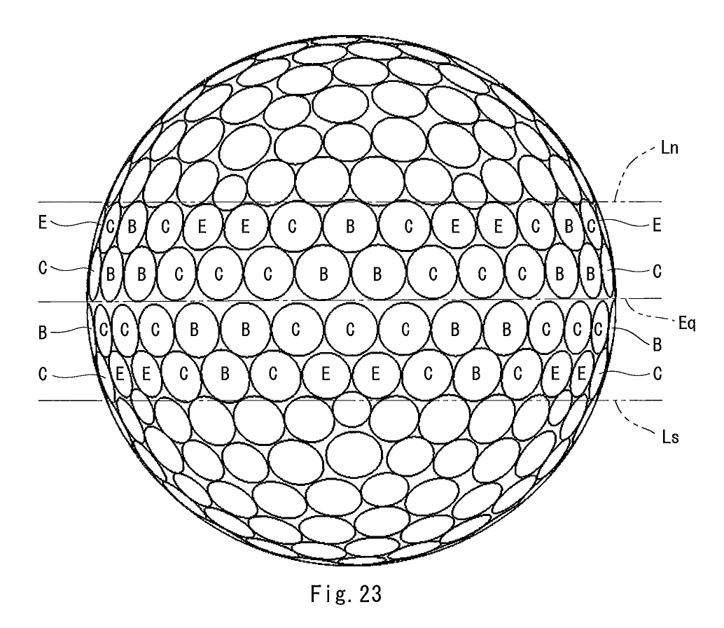

TABLE 5
Evaluation results

| | | | Compa. | Compa. | Compa. |
|---|---|---|---|---|---|
| | | | Example 4 | Example 5 | Example 6 |
| Specification | Number | | 324 | 330 | 330 |
| of pimples | Occupancy (%) | | 79.9 | 78.8 | 81.6 |
| (entire) | Σ2 | | 0.20 | 0.38 | 0.36 |
| | Dx2/Dn2 | | 1.18 | 1.33 | 1.30 |
| Specification | Number | | 120 | 102 | 120 |
| of pimples | Σ1 | | 0.15 | 0.20 | 0.21 |
| (low-latitude | Dx1/Dn1 | | 1.13 | 1.15 | 1.16 |
| region) | Diameter range | | 3.90-4.40 | 4.00-4.60 | 3.85-4.45 |
| | (mm) | | | | |
| | Kinds | | 4 | 5 | 3 |
| Number of protrusions | | | 12 | 18 | 0 |
| Adjacent of | *1 | | — | — | — |
| protrusions | *2 | | — | — | — |
| | *3 | α (deg.) | 30.0 | 19.5 | — |
| | | β (deg.) | 30.0 | 20.3 | |
| | | Number | 12 | 18 | |

| Proporsion P1 (%) | | 100 | 100 | — |
|---|---|---|---|---|
| Proporsion P2 (%) | | 0 | 0 | — |
| Proporsion P3 (%) | | 0 | 100 | — |
| Proporsion P4 (%) | | 0 | 0 | — |
| Proporsion P5 (%) | | 10 | 0 | 0 |
| Plan view of golf ball | | FIG. 18 | FIG. 20 | FIG. 22 |
| Front view of golf ball | | FIG. 19 | FIG. 21 | FIG. 23 |
| Flight | Pole shot | 239.6 | 240.0 | 238.4 |
| distance (m) | Seat shot | 238.4 | 238.5 | 236.4 |

| | | | |
|---|---|---|---|
| Appearance | B | B | C |

*1: a protrusion being adjacent to a protrusion belonging to one mold half to which itself belongs, and also being adjacent to other protrusion belonging to other mold half that is distinct form the mold half to which itself belongs.
*2: a protrusion being adjacent to two proturusions belonging to one mold half to which itself belongs to.
*3: a protrusion being adjacent to two other protrusions belonging to the other mold half that is distinct from the mold half to which itself belongs.

Details of proportions P1-P5 in Tables 3 and 4 are as follows.

P1: proportion of the number of the protrusion that meets the following requirement 1 to the total number of the protrusions.

Requirement 1: being adjacent to other protrusion belonging to other mold half that is distinct from the mold half to which itself belongs.

P2: proportion of the number of the protrusion that meets the following requirement 2 to the total number of the protrusions.

Requirement 2: being adjacent to other protrusion belonging to one mold half to which itself belongs, and also being adjacent to still other protrusion belonging to another mold half that is distinct from the mold half to which itself belongs.

P3: proportion of the number of the protrusion that meets the following requirement 3 to the total number of the protrusions.

Requirement 3: the central angle α with respect to one adjacent protrusion being different from the central angle β with respect to another adjacent protrusion.

P4: proportion of the number of the protrusion that meets both the aforementioned requirements 2 and 3 to the total number of the protrusions.

P5: proportion of the number of the protrusion that is present in the region on a latitude of equal to or less than 20° and has a diameter of less than 4.0 mm, to the total number of the protrusions that are present in the region on a latitude of equal to or less than 20°.

As shown in Tables 3 to 5, the golf ball obtained with the mold according to the present invention is excellent in the aerodynamic symmetry. Therefore, advantages of the present invention are clearly suggested by these results of evaluation.

Golf balls having a variety of structures can be manufactured with the mold according to the present invention. The foregoing description is just for illustrative examples, and various modifications can be made in the scope without departing from the principles of the present invention.

What is claimed is:

1. A mold for a golf ball comprising a pair of mold halves,
on the cavity face of the mold being provided with a large number of pimples for forming dimples, wherein:
each mold half is provided with multiple protrusions that project from the equator;
each protrusion includes a part of the pimple;
the multiple protrusions include
(a) one protrusion,
(b) other protrusion adjacent to the protrusion (a), and
(c) still other protrusion adjacent to the protrusion (a);
the central angle α between the protrusion (a) and the protrusion (b) is different from the central angle β between the protrusion (a) and the protrusion (c); and
the absolute value of the difference (α−β) is equal to or greater than 10°.

2. The mold according to claim 1, wherein the proportion P3 of the number of the protrusion that has a central angle α with respect to one adjacent protrusion being different from the central angle β with respect to another adjacent protrusion, to the total number of the protrusions is equal to or greater than 50%.

3. The mold according to claim 2, wherein the absolute value of the difference (α−β) with respect to all the protrusions is equal to or greater than 10°.

4. The mold according to claim 1, wherein the smaller angle between the angle α and angle β is less than 10°.

5. The mold according to claim 1, wherein the mold half is provided with the protrusion that is adjacent to other protrusion belonging to one mold half and that is also adjacent to still other protrusion belonging to another mold half.

6. The mold according to claim 5, wherein the proportion P2 of the number of the protrusion that is adjacent to other protrusion belonging to one mold half and that is also adjacent to still other protrusion belonging to another mold half, to the total number of the protrusions is equal to or greater than 50%.

7. The mold according to claim 1, wherein the absolute value of the difference (α−β) with respect to one protrusion is different from the absolute value of the difference (α−β) with respect to another protrusion.

8. The mold according to claim 1, wherein the proportion P5 of the number of the pimple that is present in the low-latitude region on a latitude of equal to or less than 20° and has a diameter of less than 4.0 mm, to the total number of the pimples that are present in the low-latitude region on a latitude of less than 20° is equal to or greater than 20% and equal to or less than 90%.

9. The mold according to claim 1, wherein the standard deviation of the diameters of the pimples that are present in the region on a latitude of equal to or less than 20° is equal to or less than 0.15.

10. The mold according to claim 1, wherein the number of the protrusions is 18 or greater and 33 or less.

11. The mold according to claim 1, wherein the heights of all the protrusions from the equator are identical.

12. The mold according to claim 1, wherein when all the pimples that are present in the region on a latitude of equal to or less than 20° are sorted in descending order of the diameter, the ratio (Dx/Dn) of the average diameter Dx of the pimples in the top 10% and the average diameter Dn of the pimples in the bottom 10% is equal to or less than 1.15.

13. The mold according to claim 1, wherein multiple kinds of pimples having diameters different from one another are present in the region on a latitude of equal to or less than 20°.

14. A method for manufacturing a golf ball comprising the steps of
(1) placing a material into a mold which comprises a pair of mold halves, on the cavity face of the mold being provided with a large number of pimples for forming dimples, wherein:
each mold half is provided with multiple protrusions that project from the equator;
each protrusion includes a part of the pimple;
the multiple protrusions include
(a) one protrusion,
(b) other protrusion adjacent to the protrusion (a), and
(c) still other protrusion adjacent to the protrusion (a);
the central angle α between the protrusion (a) and the protrusion (b) is different from the central angle β between the protrusion (a) and the protrusion (c); and
the absolute value of the difference (α−β) is equal to or greater than 10°, and
(2) forming the dimples having a shape inverted from the shape of the pimple by allowing the material to flow in the mold.

15. A mold for a golf ball comprising a pair of mold halves,
on the cavity face of the mold being provided with a large number of pimples for forming dimples, wherein
each mold half is provided with multiple protrusions that project from the equator,
each protrusion includes a part of the pimple,
the proportion P1 of the number of the protrusion being adjacent to other protrusion belonging to other mold half that is distinct from the mold half to which itself belongs, to the total number of the protrusions is equal to or greater than 50%,
the proportion P5 of the number of the pimple being that is present in the region on a latitude of equal to or less than 20° and has a diameter of less than 4.0 mm, to the total number of the protrusions that are present in the region on a latitude of equal to or less than 20° is equal to or greater than 20% and equal to or less than 90%, and
the standard deviation of the diameters of all the pimples that are present in the region on a latitude of equal to or less than 20° is equal to or less than 0.15.

16. The mold according to claim 15, wherein the number of the protrusions is 18 or greater and 33 or less.

17. The mold according to claim 15, wherein the heights of all the protrusions from the equator are identical.

18. The mold according to claim 15, wherein when all the pimples that are present in the region on a latitude of equal to or less than 20° are sorted in descending order of the diameter, the ratio (Dx/Dn) of the average diameter Dx of the pimples in the top 10% and the average diameter Dn of the pimples in the bottom 10% is equal to or less than 1.15.

19. The mold according to claim 15, wherein multiple kinds of pimples having diameters different from one another are present in the region on a latitude of equal to or less than 20°.

20. A method for manufacturing a golf ball comprising the steps of
(1) placing a material into a mold which comprises a pair of mold halves, on the cavity face of the mold being provided with a large number of pimples for forming dimples, wherein:
each mold half is provided with multiple protrusions that project from the equator;
each protrusion includes a part of the pimple;
the proportion P1 of the number of the protrusion being adjacent to other protrusion belonging to other mold half that is distinct from the mold half to which itself belongs, to the total number of the protrusions is equal to or greater than 50%;
the proportion P5 of the number of the pimple being that is present in the region on a latitude of equal to or less than 20° and has a diameter of less than 4.0 mm, to the total number of the protrusions that are present in the region on a latitude of equal to or less than 20° is equal to or greater than 20% and equal to or less than 90%; and
the standard deviation of the diameters of all the pimples that are present in the region on a latitude of equal to or less than 20° is equal to or less than 0.15, and
(2) forming the dimples having a shape inverted from the shape of the pimple by allowing the material to flow in the mold.
